(19) United States
(12) Patent Application Publication
(10) Pub. No.: US 2007/0050649 A1
(43) Pub. Date: Mar. 1, 2007

(54) POWER SAVING ELECTRONIC APPARATUS AND METHOD

(76) Inventor: Jun Zhang, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/307,591

(22) Filed: Feb. 14, 2006

(30) Foreign Application Priority Data
Aug. 23, 2005 (CN) 200510036806.7

(51) Int. Cl. G06F 1/00

(52) U.S. Cl. 713/300

(57) ABSTRACT

A power saving electronic apparatus includes a processing unit; a power management unit for selectively turning on or off a power supplied to the processing unit; and a control unit connected to the processing unit and the power management unit. The control unit is provided for telling the processing unit to prepare for a power saving mode when a power saving command is created, and for controlling the power management unit to turn off the power supplied to the processing unit when the processing unit is ready for the power saving mode. Related power saving methods is also provided.

### FIELD OF THE INVENTION

This invention relates to electronic apparatuses and, more particularly, to a power saving electronic apparatus and a power saving method.

### DESCRIPTION OF RELATED ART

Electronic apparatus, such as disc players, portable computers, desktop computers, serving as information processing terminals, become widely used. In order to reduce power consumption of such electronic apparatus, various power saving modes, including a sleep mode and a standby mode, are developed.

Referring to FIG. 7, a traditional electronic apparatus 1, such as a disc player, a portable computer, and a desktop computer, includes an input terminal 10, a processing unit 12, a power management unit 14, and a display unit 16. The processing unit 12, such as a servo and decode circuit of a disc player, or a central processing unit (CPU) of a computer, is provided for performing main tasks of the electronic apparatus 1. The power management unit 14 is provided for controlling powers supplied to the processing unit 12 and to the display unit 16. When a user wants to temporarily discontinue execution of the electronic apparatus 1 and inputs a sleep command via the input terminal 10, the processing unit 10 interrupts a current program and generates a pulse signal to be sent to the power management unit 14. After receiving the pulse signal from the processing unit 10, the power management unit 14 turns off powers supplied to some particular components such as the display unit 14.

However, in the above mentioned conventional power saving modes, the processing unit 12 still has a low power consumption after the power management unit 14 has turned off powers supplied to some particular components.

Therefore, an power saving apparatus which has a lower power consumption is desired.

### SUMMARY OF INVENTION

A power saving electronic apparatus includes a processing unit; a power management unit for selectively turning on or off a power supplied to the processing unit; and a control unit connected to the processing unit and the power management unit. The control unit is provided for telling the processing unit to prepare for a power saving mode when a power saving command is created, and for controlling the power management unit to turn off the power supplied to the processing unit when the processing unit is ready for the power saving mode.

A power saving method includes the steps of: telling a processing unit to prepare for a power saving mode when a power saving command is created; waiting until the processing unit is ready for the power saving mode; and controlling a power management unit to turn off a power supplied to the processing unit when the processing unit is ready for the power saving mode.

A power saving method includes the steps of: informing a processing unit of preparation for a power saving mode when a power saving command is created; performing in the processing unit the preparation of ready to the power saving mode; and turning off power supplied to the processing unit when the processing unit is ready for the power saving mode.

Other advantages and novel features will become more apparent from the following detailed description of preferred embodiments when taken in conjunction with the accompanying drawings, in which:

### BRIEF DESCRIPTION OF DRAWINGS

FIG. 1 is a block diagram of a power saving electronic apparatus in accordance with a preferred embodiment, the power saving electronic apparatus including a controlling unit;

FIG. 2 is a schematic diagram of an internal circuit of the power saving electronic apparatus of FIG. 1;

FIG. 3 is a block diagram of the controlling unit of the power saving electronic apparatus of FIG. 1;

FIG. 4 is a flow chart illustrating a working procedure of the control unit in accordance with a preferred embodiment;

FIG. 5 is a flow chart illustrating a power saving procedure of a power saving method in accordance with a preferred embodiment;

FIG. 6 is a flow chart illustrating a restoring procedure of the power saving method of FIG. 5; and

FIG. 7 is a block diagram of a traditional electronic apparatus.

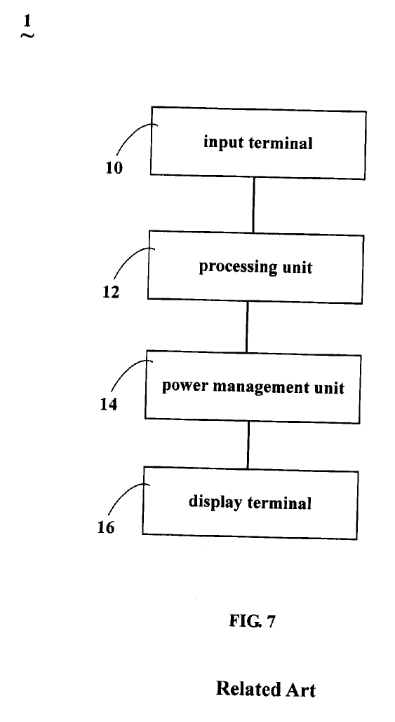

### DETAILED DESCRIPTION

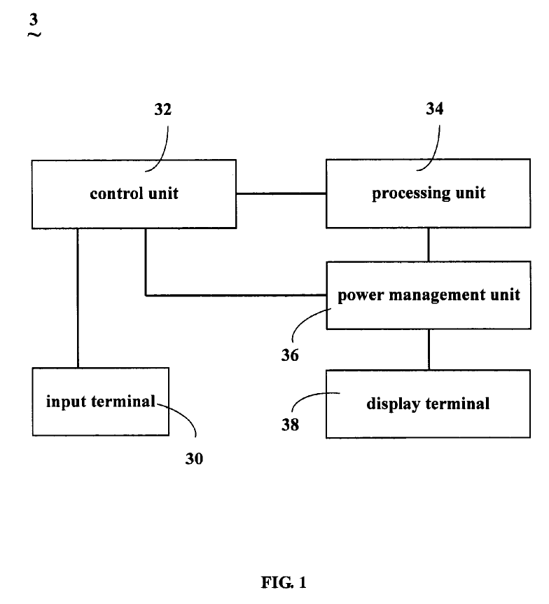

Referring to FIG. 1, a block diagram of a power saving electronic apparatus 3 in accordance with a preferred embodiment is illustrated. The power saving electronic apparatus 3 can be a disc player, or a computer, and the processing unit 34 can be a servo and decode circuit, or a CPU, accordingly. The power saving electronic apparatus 3 includes an input terminal 30, a control unit 32, a processing unit 34, a power management unit 36, and a display terminal 38. The input terminal 30, such as, a mouse, a keyboard, or a remote controller, is used for inputting commands. The control unit 32 is a micro control unit (MCU), and is provided for notifying the processing unit 34 to prepare for a power saving mode based on input signals from the input terminal 30. The control unit 32 is also provided for generating controlling signals to control operations of the power management 36 when the processing unit 34 is ready for the power saving mode. The power management unit 36 is provided for controlling powers supplied to the processing unit 34 and the display terminal 38 according to the controlling signals generated by the control unit 32. When the power saving electronic apparatus 3 is ready to go into the power saving mode, the power management unit 36 turns off the powers supplied to the processing unit 34 and the display terminal 38. When the power saving electronic apparatus 3 is in a normal working mode, the power management unit 36 turns on the powers supplied to the processing unit 34 and the display terminal 38.

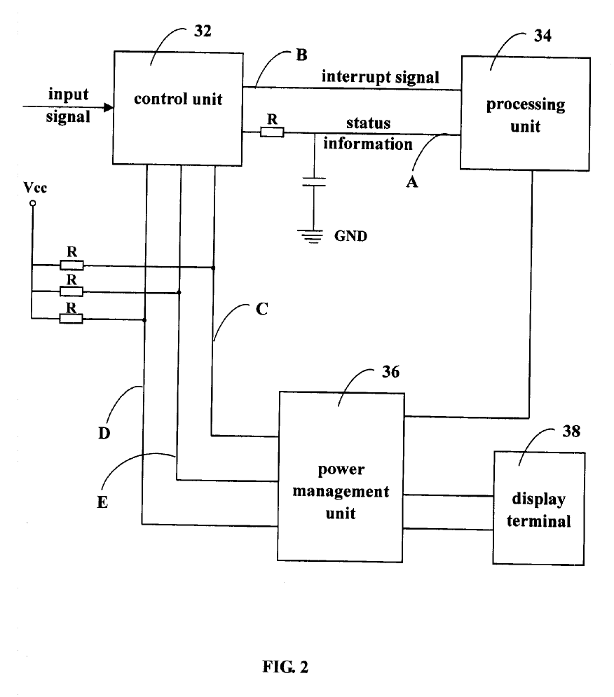

Referring to FIG. 2, an internal circuit of the power saving electronic apparatus 3 is illustrated. The control unit 32 connects to the processing unit 34 via a first wire A and a second wire B. The first wire A is provided for transmitting an interrupt signal, which tells the processing unit 34 to prepare for the power saving mode. The first wire A employs a serial communicating protocol, such as an inter-integrated circuit (I2C), a serial peripheral interface (SPI), and a data communication interface system provided in another copending application, which is named as “DATA TRANSMISSION INTERFACE SYSTEM AND METHOD FOR ELECTRONIC COMPONENT”, and filed by the same applicant as this application. The second wire B is provided for transmitting status information of the processing unit 34. For example, when being ready for the power saving mode, the processing unit 34 switches the second wire B from a high level state to a low level state, so as to notify the control unit 32 that the processing unit 34 is ready for the power saving mode. In other alternative embodiments, the second wire B also can employ one of the above-mentioned communication protocols. The control unit 32 is connected to the power management unit 36 via a third wire C, a fourth wire D, and a fifth wire E. The third wire C, the fourth wire D, and the fifth wire E are provided for transmitting the controlling signals from the control unit 32 to the power management unit 36. The controlling signals are represented by switching signals of the third wire C, the fourth wire D, and the fifth wire E. For example, the control unit 32 controls the third wire C, the fourth wire D, and the fifth wire E to switch from a low level state to a high level state, which tells the power management unit to turn off the powers supplied to the processing unit 34 and the display terminal 38. That is, when the third wire C, the fourth wire D, and the fifth wire E are in the low level state, the power management unit 36 turns on the powers supplied to processing unit 34 and the display terminal 38. On the contrary, when the third wire C, the fourth wire D, and the fifth wire E are switched to the high level state, the power management unit 36 turns off the powers supplied to the processing unit 34 and the display terminal 38.

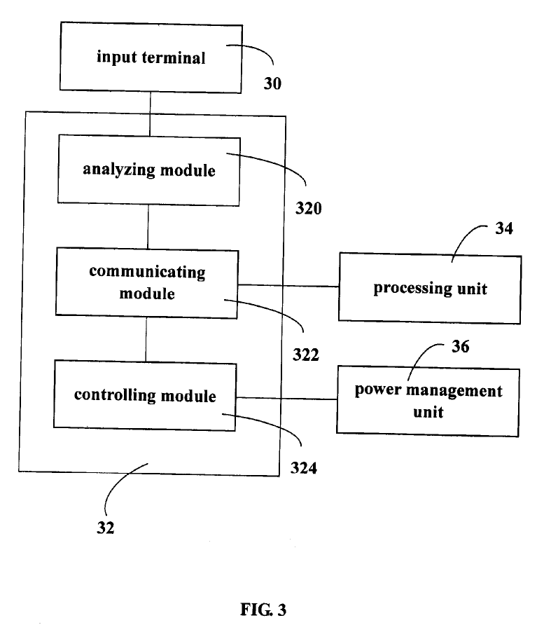

Referring to FIG. 3, a block diagram of the controlling unit 32 is illustrated. The controlling unit 32 includes an analyzing module 320, a communicating module 322, and a controlling module 324. The analyzing module 320 is provided for receiving an input signal from the input terminal 30, and determining whether the input signal is a power saving command. If the input signal is a power saving command, the analyzing module 320 notifies the communicating module 322 of the power saving command. If the input signal is not a power saving command, the analyzing module 320 notifies the communicating module 322 that the input signal is not a power saving command. The communicating module 322 is provided for communicating with the processing unit 34. When the input signal is a power saving command, the communicating module 322 generates the interrupt signal to tell the processing unit 34 to prepare for the power saving mode. When the input signal is not a power saving command, the communicating module 322 generates the interrupt signal to the processing unit 34 to tell the processing unit 34 to perform programs corresponding to the input signal. The controlling module 324 is provided for generating the control signals to the power management unit 36 to turn off the powers supplied to the processing unit 34 and the display terminal 38, when receiving the status information indicating that the processing unit 34 is ready for the power saving mode.

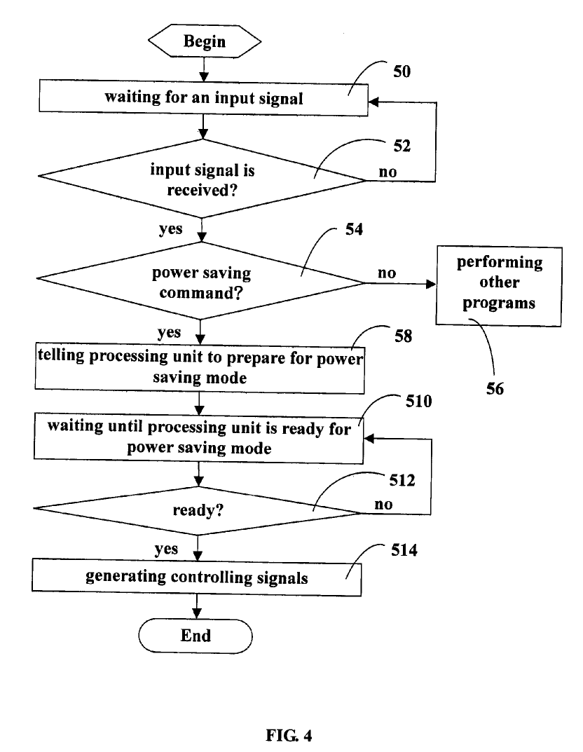

Referring to FIG. 4, a flow chart of a working procedure of the control unit in accordance with a preferred embodiment is illustrated. Firstly, in step 50, the control unit 32 waits for an input signal from the input terminal 30. In step 52, the control unit 32 detects whether an input signal is received. If an input signal is received, the analyzing module 320 analyzes the received input signal and determines whether the input signal is a power saving command (step 54). If the input signal is not the power saving command, the communicating module 322 generates an interrupt signal telling the processing unit 34 to perform other programs corresponding to the input signal (step 56). If the input signal is the power saving command, the communicating module 322 generates an interrupt signal telling the processing unit 34 to prepare for the power saving mode (step 58). Then, the communicating module 322 waits for status information indicating the processing unit 34 is ready for the power saving mode (step 510). The communicating module 322 detects the state of the second wire B and determines whether the processing unit 34 is ready for the power saving mode (step 512). If the communicating module 322 receives status information indicating the processing unit 34 is ready for the power saving mode, the controlling module 324 generates controlling signals and sends the controlling signals to the power management unit 36 (step 514).

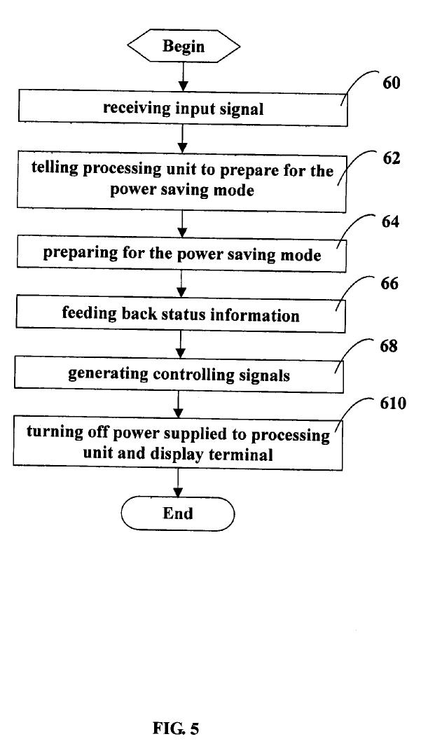

Referring to FIG. 5, a flow chart of a power saving procedure of a power saving method in accordance with a preferred embodiment is illustrated. Firstly, in step 60, the control unit 32 receives an input signal from the input terminal 30. Then, the control unit 32 generates an interrupt signal based on the input signal and sends the interrupt signal to the processing unit 34, telling the processing unit 34 to prepare for the power saving mode (step 62). The processing unit 34 prepares for the power saving mode. The processing unit 34 stores information on current working status of the processing unit 34 into a memory device (not shown). After finishing storing information on the current working status, the processing unit 34 feeds back status information to the control unit 32 to notify the control unit 32 that the processing unit 34 is ready for the power saving mode (step 66). Upon receiving the status information indicating the processing unit 34 is ready, the control unit 32 generates controlling signals to the power management unit 36 (step 68). Finally, the power management unit 36 turns off the powers supplied to the processing unit 34 and the display terminal 38.

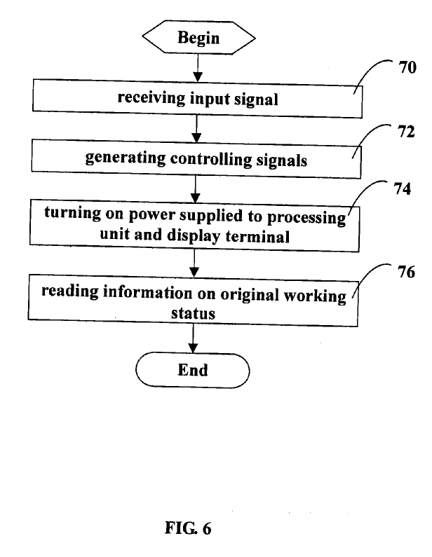

Referring to FIG. 6, a flow chart of a restoring procedure of the power saving method of FIG. 5 is illustrated. Firstly, in step 70, the control unit 32 receives an input signal from the input terminal 30. Then, the control unit 32 generating controlling signals to the power management unit 36 (step 72). Upon receiving the controlling signals, the power management unit 36 turns on the powers supplied to the processing unit 34 and the display terminal 38 (step 74). Finally, the processing unit 34 reads information on the stored working status from the memory device (step 76). Hence, the power saving electronic apparatus 3 is restored to the same working status as that before the power saving procedure.

The embodiments described herein are merely illustrative of the principles of the present invention. Other arrangements and advantages may be devised by those skilled in the art without departing from the spirit and scope of the present invention. Accordingly, the present invention should be deemed not to be limited to the above detailed description, but rather by the spirit and scope of the claims that follow, and their equivalents.

What is claimed is:

1. A power saving electronic apparatus, comprising:
a processing unit;
a power management unit for selectively turning on or off a power supplied to the processing unit; and
a control unit connected to the processing unit and the power management unit, and being used for telling the processing unit to prepare for a power saving mode when a power saving command is created, and for controlling the power management unit to turn off the power supplied to the processing unit when the processing unit is ready for the power saving mode.

2. The power saving electronic apparatus as claimed in claim 1, wherein the control unit comprises a communicating module for communicating with the processing unit to tell the processing unit to prepare for the power saving mode and to receive status information indicating the processing unit is ready for the power saving mode.

3. The power saving electronic apparatus as claimed in claim 2, wherein status information is a switching signal from one of a high level state and a low level state to the other one of the high level state and the low level state.

4. The power saving electronic apparatus as claimed in claim 1, wherein the processing unit communicates with the control unit based on a serial protocol.

5. The power saving electronic apparatus as claimed in claim 1, wherein the control unit comprises a controlling module for generating controlling signals to control the power management unit to turn off the power supplied to the processing unit.

6. The power saving electronic apparatus as claimed in claim 5, wherein the controlling signals are switching signals from one of a high level state and a low level state to the other one of the high level state and the low level state.

7. The power saving electronic apparatus as claimed in claim 1, further comprising a display terminal connected to the power management unit, the power management unit is controlled by the control unit to turn off a power supplied to the display terminal when the processing unit is ready for the power saving mode.

8. The power saving electronic apparatus as claimed in claim 1, further comprising an input terminal for inputting a power saving command.

9. The power saving electronic apparatus as claimed in claim 1, wherein the control unit is a micro control unit.

10. A power saving method comprising:
telling a processing unit to prepare for a power saving mode when a power saving command is created;
waiting until the processing unit is ready for the power saving mode; and
controlling a power management unit to turn off a power supplied to the processing unit when the processing unit is ready for the power saving mode.

11. The power saving method as claimed in claim 10, further comprising: receiving status information indicating the processing unit is ready for the power saving mode from the processing unit feeding back.

12. The power saving method as claimed in claim 11, wherein the status information is a switching signal from one of a high level state and a low level state to the other one of the high level state and the low level state.

13. The power saving method as claimed in claim 10, further comprising: generating an interrupt signal based on the power saving command and sending the interrupt signal to the processing unit to tell the processing unit to prepare for the power saving mode.

14. The power saving method as claimed in claim 13, wherein the control unit sends the interrupt signal to the processing unit based on a serial protocol.

15. The power saving method as claimed in claim 10, further comprising a step of generating controlling signals to the power management unit to control the power management unit to turn off the power supplied to the processing unit, the controlling signals being a switching signal from one of a high level state and a low level state to the other one of the high level state and the low level state.

16. The power saving method as claimed in claim 10, further comprising: controlling the power management unit to turn on the power supplied to the processing unit when a restoring command is created.

17. A power saving method comprising:
informing a processing unit of preparation for a power saving mode when a power saving command is created;
performing in the processing unit the preparation of ready to the power saving mode; and turning off power supplied to the processing unit when the processing unit is ready for the power saving mode.

18. The power saving method as claimed in claim 17, wherein the step of performing the preparation of ready to the power saving mode comprises a step of storing information on working status of the processing unit.

19. The power saving method as claimed in claim 18, further comprising:
turning on the power supplied to the processing unit when a restoring command is created;
reading the stored information on working status of the processing unit to restore the power saving electronic apparatus to an original working status before the power saving electronic apparatus goes into the power saving mode.
